(19) United States
(12) Patent Application Publication
(10) Pub. No.: US 2025/0240172 A1
(43) Pub. Date: Jul. 24, 2025

(54) VERIFICATION METHODS AND APPARATUS THEREOF

(71) Applicant: MEDIATEK INC., Hsinchu City (TW)

(72) Inventor: Po-Chun LIN, Hsinchu City (TW)

(21) Appl. No.: 18/419,717

(22) Filed: Jan. 23, 2024

(51) Int. Cl. H04L 9/32; H04L 9/08

(52) U.S. Cl. CPC H04L 9/3247; H04L 9/0852; H04L 9/3236

(57) ABSTRACT

A verification method is provided. The verification method may be applied to an apparatus. The verification method may include the following steps. The apparatus may generate a first random nonce. Then, the apparatus may bind the first random nonce to the signing data. Then, the apparatus may calculate the first signature according to the hash-based post-quantum cryptography (PQC) algorithm and the signing data bound to the first random nonce to obtain the first verification time. Then, the apparatus may determine whether the first verification time meets the quality of service (QOS) condition. The apparatus may adopt the first signature for a verification process in response to the first verification time meeting the QoS condition.

### BACKGROUND OF THE INVENTION

### Field of the Invention

The invention generally relates to verification technology, and more particularly, to a verification technology based on hash-based post-quantum cryptography (PQC) algorithm.

### Description of the Related Art

The post-quantum cryptography (PQC) technology is a cryptographic algorithm against the cryptanalytic attack by the quantum computer. The hash-based PQC algorithm is one type of PQC algorithm. Comparing to the non-PQC algorithm, PQC algorithm may spend longer verification time. In addition, the verification time may be varied based on the input data of the PQC algorithm.

In addition, the hash-based PQC algorithm may be applied to the secure boot process. The boot time of the secure boot process may be an important requirement for user experience. However, as the variance of the input data of the PQC algorithm, longer verification time may be generated in the secure boot process.

Therefore, how to maintain the quality of service (QOS) of secure boot process is a topic that is worthy of discussion.

### BRIEF SUMMARY OF THE INVENTION

Verification methods and apparatus are provided to overcome the problems mentioned above.

An embodiment of the invention provides a verification method. The verification method may be applied to an apparatus. The verification method may include the following steps. The apparatus may generate a first random nonce. Then, the apparatus may bind the first random nonce to the signing data. Then, the apparatus may calculate a first signature according to a hash-based post-quantum cryptography (PQC) algorithm and the signing data bound to the first random nonce to obtain the first verification time. Then, the apparatus may determine whether the first verification time meets the quality of service (QOS) condition. The apparatus may adopt the first signature for a verification process in response to the first verification time meeting the QoS condition.

In some embodiments, the apparatus may generate a second random nonce in response to the first verification time not meeting the QoS condition, wherein the first random nonce is different from the second random nonce. Then, the apparatus may bind the second random nonce to the signing data. Then, the apparatus may calculate a second signature according to the hash-based PQC algorithm and the signing data bound to the second random nonce to obtain the second verification time. Then, the apparatus may determine whether the second verification time meets the QoS condition. The apparatus may adopt the second signature for the verification process in response to the second verification time meeting the QoS condition.

In some embodiments, in step of calculating of the first signature, the apparatus may generate a hash value according to the hash-based PQC algorithm and the signing data bound to the first random nonce, and signing the hash value according to a private key to generate the first signature.

In some embodiments, the QoS condition comprises a target time range. In some embodiments, the apparatus may determine that the first verification time meets the QoS condition in response to the first verification time is in the default time range. In addition, the apparatus may determine that the first verification time does not meet the QoS condition in response to the first verification time is over or less than the target time range. In some embodiments, the target time range is over the normal distribution or less than the normal distribution.

In some embodiments, the hash-based PQC algorithm comprises an extended Merkle signature scheme (XMSS), a Leighton-Micali signature (LMS) or a SPHINCS+.

An embodiment of the invention provides an apparatus for data reordering. The apparatus may include a random nonce generator and a processor. The processor may be coupled to the random nonce generator. The processor may be configured to generate, via the random nonce generator, a first random nonce. The processor may be configured to bind the first random nonce to the signing data. The processor may be configured to calculate a first signature according to a hash-based post-quantum cryptography (PQC) algorithm and the signing data bound to the first random nonce to obtain the first verification time. The processor may be configured to determine whether the first verification time meets the quality of service (QOS) condition. In addition, the processor may be configured to adopt the first signature for a verification process in response to the first verification time meeting the QoS condition.

Other aspects and features of the invention will become apparent to those with ordinary skill in the art upon review of the following descriptions of specific embodiments of the verification method and the apparatus.

### BRIEF DESCRIPTION OF THE DRAWINGS

The invention will become more fully understood by referring to the following detailed description with reference to the accompanying drawings, wherein:

FIG. 1 is a block diagram of a verification apparatus 100 according to an embodiment of the invention.

FIG. 2 is a schematic diagram illustrating a sign process according to an embodiment of the invention.

FIG. 3 is a schematic diagram illustrating a verification process according to another embodiment of the invention.

FIG. 4 is a schematic diagram illustrating a verification time distribution according to an embodiment of the invention.

FIG. 5 is a flow chart illustrating a verification method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

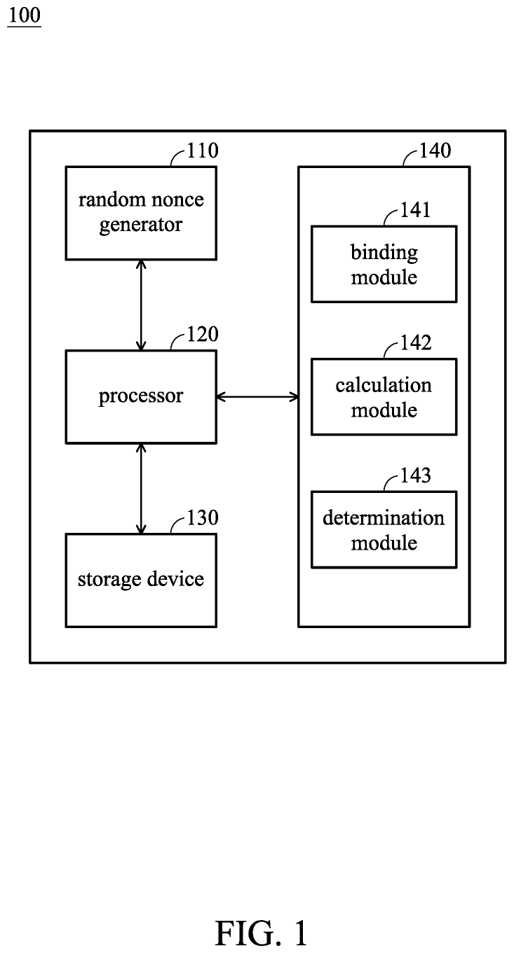

FIG. 1 is a block diagram of a verification apparatus 100 according to an embodiment of the invention. As shown in FIG. 1, the verification device 100 may comprise a random nonce generator 110, a processor 120, a storage device 130, and a function modules and circuits 140. It should be noted that, in order to clarify the concept of the invention, FIG. 1 presents a simplified block diagram in which only the elements relevant to the invention are shown. However, the invention should not be limited to what is shown in FIG. 1. For example, the verification device 100 may comprise other elements.

According to an embodiment of the invention, the random nonce generator 110 may be used to generate the random nonce.

According to an embodiment of the invention, the processor 120 may be coupled to the random nonce generator 110, the storage device 130, and the function modules and circuits 140 to control the operations of the random nonce generator 110, the storage device 130, and the function modules and circuits 140. According to an embodiment of the invention, the processor 120 may also be arranged to execute the program codes of the software module(s) of the corresponding random nonce generator 110 and the function modules and circuits 140. The program codes accompanied by specific data in a data structure may also be referred to as a processor logic unit or a stack instance when being executed. Therefore, the processor 120 may be regarded as being comprised of a plurality of processor logic units, each for executing one or more specific functions or tasks of the corresponding software modules.

The storage device 130 may store the software and firmware program codes, system data, user data, etc. of the verification apparatus 100. The storage device 130 may be a volatile memory such as a Random Access Memory (RAM); a non-volatile memory such as a flash memory or Read-Only Memory (ROM); a hard disk; or any combination thereof. In an embodiment, the storage device 130 further may stores a private key and a public key. In another embodiment, the private key and the public key may be respectively stored in a specific storage device, e.g., a key storage.

The function modules and circuits 140 may comprise a binding module (or circuit) 141, a calculation module (or circuit) 142 and a determination module (or circuit) 143. The processor 120 may execute different modules or circuits in the function modules and circuits 140 to perform embodiments of the present invention. In the embodiment of the invention, the binding module 141 may bind the signing data and the random nonce generated by the random nonce generator 110. The calculation module 142 may calculate the first signature according to a hash-based post-quantum cryptography (PQC) algorithm and the signing data bound to the random nonce to obtain a verification time. The determination module 143 may determine whether the verification time meets the quality of service (QOS) condition. When the verification time meets the QoS condition the determination module 143 may determine to adopt the signature corresponding to the verification time for the verification process.

According to an embodiment of the invention, when signing data (e.g., updated firmware or image data, but the invention should not be limited thereto) for secure boot need to be signed and verified, in the sign process, the random nonce generator 110 of the verification apparatus 100 may generate a random nonce (e.g., the first random nonce). Then, the verification apparatus 100 may bind the signing data and the random nonce generated by the random nonce generator 110. That is, the input data (i.e., the signing data bound to the random nonce) for generating the signature corresponding to the signing data may be verified based on the different random nonce.

Then, the verification apparatus 100 may calculate or generate a signature (or digital signature) according to a hash-based PQC algorithm and the signing data bound to the random nonce to obtain a verification time. Specifically, the verification apparatus 100 may generate a hash value according to a hash function (e.g., SHA-256) of the hash-based PQC algorithm and the signing data bound to the random nonce first. Then, the verification apparatus 100 may sign the hash value according to the private key to generate the signature. According to the process of generating the signature, the verification apparatus 100 may derive the verification time corresponding to the signature. That is, the verification apparatus 100 may know how many times of hush function needs to be performed for the verification corresponding to the signature.

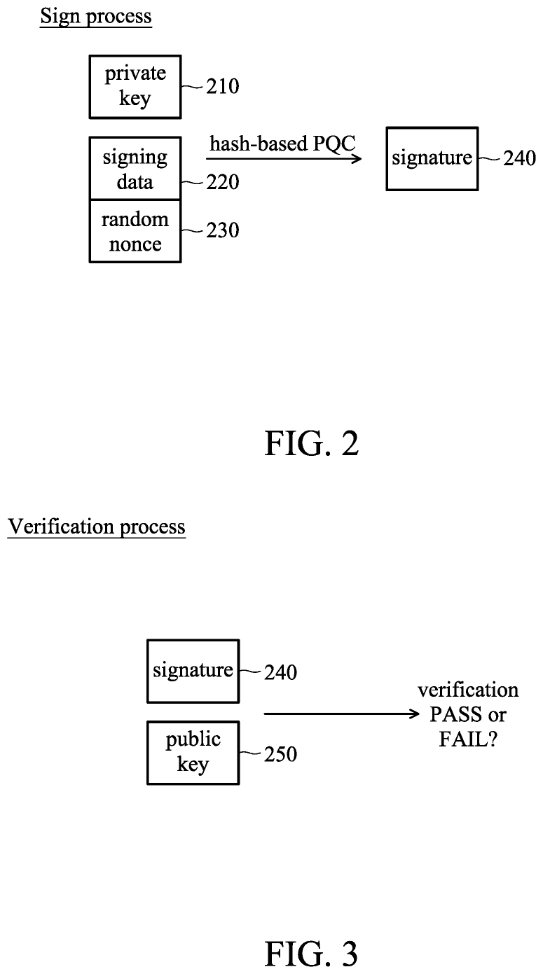

FIG. 2 is a schematic diagram illustrating a sign process according to an embodiment of the invention. As shown in FIG. 2, the verification apparatus 100 may generate the signature 240 based on the private key 210, the signing data 220 bound to the random nonce 230, and the hash-based PQC algorithm.

According to an embodiment of the invention, the hash-based PQC algorithm may comprise extended Merkle signature scheme (XMSS), Leighton-Micali signature (LMS) or SPHINCS+, but the invention should not be limited thereto.

After verification apparatus 100 calculate the signature, the verification apparatus 100 may determine whether the verification time meets the quality of service (QOS) condition. According to an embodiment of the invention, the QoS condition may comprise a target time range. The target time range may correspond to a default number of times of performing hash function (e.g., the target time range may comprise 50˜100 times of performing hash function). For example, the verification apparatus 100 may determine that the verification time meets the QoS condition when the verification time is within the target time range, and the verification apparatus 100 may determine that the verification time does not meet the QoS condition in response to the verification time is over or less than the target time range (i.e., the verification time is outside the target time range). According to an embodiment of the invention, the target time range may be over the normal distribution or less than the normal distribution based on different requirements, where the normal distribution means that the normal verification time range for the signing data in the verification process. According to an embodiment of the invention, the target time range may be set to achieve a faster verification time (i.e., better secure boot QoS).

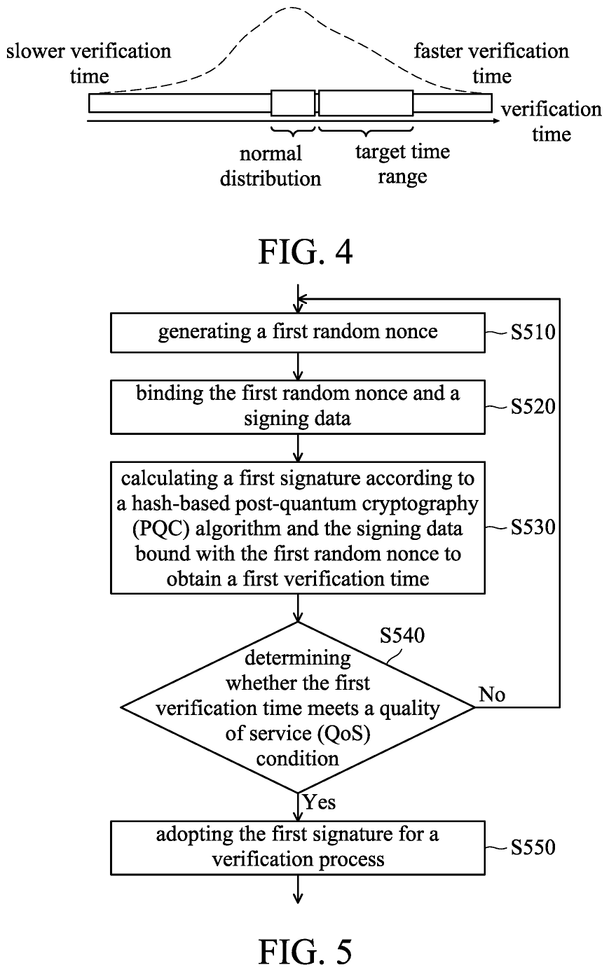

FIG. 4 is a schematic diagram illustrating a verification time distribution according to an embodiment of the invention. As shown in FIG. 4, the target time range may be over the normal distribution, i.e., the verification time corresponding to the target time range may be faster than the verification time corresponding to the normal distribution. Therefore, the faster secure boot time will be achieved.

When the verification apparatus 100 determines that the verification time meets the QoS condition, the verification apparatus 100 may adopt the signature for the verification process. FIG. 3 is a schematic diagram illustrating a verification process according to an embodiment of the invention. As shown in FIG. 3, the verification apparatus 100 may perform the verification process according to the signature 240 and a public key 250, wherein the public key 250 may correspond to the private key 210. Specifically, in the verification process, the verification apparatus 100 may calculate the root node value of the signature 240 according to the hash-based PQC algorithm. Then, the verification apparatus 100 may compare the root node value of the signature 240 with the root node value of the private key 250. If the root node value of the signature 240 and the root node value of the private key 250 are the same, the verification for the signature is success (i.e., verification PASS). If the root node value of the signature 240 and the root node value of the private key 250 are not the same, the verification for the signature is failure (i.e., verification FAIL). In addition, because the verification time has met the QoS condition in the verification process, the verification time will be reduced.

When the verification apparatus 100 determines that the verification time does not meet the QoS condition, the random nonce generator 110 of the verification apparatus 100 may generate another random nonce. Then, the verification apparatus 100 may perform the sign process as discussion above again.

For example, the random nonce generator 110 of the verification apparatus 100 may a second random nonce. The second random nonce is different from the first random nonce. Then, the verification apparatus 100 may bind the second random nonce to the signing data. Then, the verification apparatus 100 may calculate another signature (e.g., the second signature) according to the hash-based PQC algorithm and the signing data bound to the second random nonce to obtain another verification time (e.g., the second verification time). Then, the verification apparatus 100 may determine whether the second verification time meets the QoS condition. When the verification apparatus 100 determines that the second verification time meets the QoS condition, the verification apparatus 100 may adopt the second signature for the verification process. When the verification apparatus 100 determines that the second verification time does not meet the QoS condition, the random nonce generator 110 of the verification apparatus 100 may generate another random nonce, and the verification apparatus 100 may perform the sign process as discussion above again.

FIG. 5 is a flow chart illustrating a verification method according to an embodiment of the invention. The data reordering method can be applied to the verification apparatus 100. As shown in FIG. 5, in step S510, the verification apparatus 100 may generate a first random nonce.

In step S520, the verification apparatus 100 may bind the first random nonce to the signing data.

In step S530, the verification apparatus 100 may calculate a first signature according to a hash-based post-quantum cryptography (PQC) algorithm and the signing data bound to the first random nonce to obtain the first verification time.

In step S540, the verification apparatus 100 may determine whether the first verification time meets the quality of service (QOS) condition.

In step S550, the verification apparatus 100 may adopt the first signature for a verification process in response to the first verification time meeting the QoS condition.

In addition, in the verification method, the flow may back to step S510 in response to the first verification time not meeting the QoS condition. For example, the verification apparatus 100 may generate a second random nonce in response to the first verification time not meeting the QoS condition, wherein the first random nonce is different from the second random nonce. Then, the verification apparatus 100 may bind the second random nonce to the signing data. Then, the verification apparatus 100 may calculate a second signature according to the hash-based PQC algorithm and the signing data bound to the second random nonce to obtain the second verification time. Then, the verification apparatus 100 may determine whether the second verification time meets the QoS condition. In response to the second verification time meeting the QoS condition, the verification apparatus 100 may adopt the second signature for the verification process.

According to an embodiment of the invention, in the verification method, step S530 may comprise the following steps. The verification apparatus 100 may generate a hash value according to the hash-based PQC algorithm and the signing data bound to the first random nonce, and sign the hash value according to the private key to generate the first signature.

According to an embodiment of the invention, in the verification method, the QoS condition comprises a target time range.

According to an embodiment of the invention, in the verification method, the verification apparatus 100 may determining that the first verification time meets the QoS condition in response to the first verification time being within the target time range. In addition, the verification apparatus 100 may determine that the first verification time does not meet the QoS condition in response to the first verification time being over or less than the target time range.

According to an embodiment of the invention, in the verification method, the target time range is over the normal distribution or less than the normal distribution.

According to an embodiment of the invention, in the verification method, the hash-based PQC algorithm comprises an extended Merkle signature scheme (XMSS), a Leighton-Micali signature (LMS) or a SPHINCS+.

In the verification method provided in the invention, the verification time can be adjusted according to different random nonce bounding with the signing data. Therefore, even if the length of the signing data is varied, the secure boot time still also can be maintained.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A verification method, comprising:
generating, by a processor of an apparatus, a first random nonce;
binding, by the processor, the first random nonce to signing data;
calculating, by the processor, a first signature according to a hash-based post-quantum cryptography (PQC) algorithm and the signing data bound to the first random nonce to obtain a first verification time;
determining, by the processor, whether the first verification time meets a quality of service (QOS) condition; and
adopting, by the processor, the first signature for a verification process in response to the first verification time meeting the QoS condition.

2. The verification method of claim 1, further comprising:
generating, by the processor, a second random nonce in response to the first verification time not meeting the QOS condition, wherein the first random nonce is different from the second random nonce;
binding, by the processor, the second random nonce to the signing data;
calculating, by the processor, a second signature according to the hash-based PQC algorithm and the signing data bound to the second random nonce to obtain a second verification time;
determining, by the processor, whether the second verification time meets the QoS condition; and
adopting, by the processor, the second signature for the verification process in response to the second verification time meeting the QoS condition.

3. The verification method of claim 1, wherein the calculating of the first signature comprises:
generating, by the processor, a hash value according to the hash-based PQC algorithm and the signing data bound to the first random nonce; and
signing, by the processor, the hash value according to a private key to generate the first signature.

4. The verification method of claim 1, wherein the QoS condition comprises a target time range.

5. The verification method of claim 4, further comprising:
determining, by the processor, that the first verification time meets the QoS condition in response to the first verification time being within the target time range; or
determining, by the processor, that the first verification time does not meet the QoS condition in response to the first verification time being over or less than the target time range.

6. The verification method of claim 4, wherein the target time range is over a normal distribution or less than the normal distribution.

7. The verification method of claim 1, wherein the hash-based PQC algorithm comprises an extended Merkle signature scheme (XMSS), a Leighton-Micali signature (LMS) or a SPHINCS+.

8. An apparatus for verification method, comprising:
a random nonce generator; and
a processor, coupled to the random nonce generator and configured to:
generate, via the random nonce generator, a first random nonce;
bind the first random nonce to a signing data;
calculate a first signature according to a hash-based post-quantum cryptography (PQC) algorithm and the signing data bound to the first random nonce to obtain a first verification time;
determine whether the first verification time meets a quality of service (QoS) condition; and
adopt the first signature for a verification process in response to the first verification time meeting the QoS condition.

9. The apparatus of claim 8, wherein the processor is further configured to:
generate, via the random nonce generator, a second random nonce in response to the first verification time not meeting the QoS condition, wherein the first random nonce is different from the second random nonce;
bind the second random nonce to the signing data;
calculate a second signature according to the hash-based PQC algorithm and the signing data bound to the second random nonce to obtain a second verification time;
determine whether the second verification time meets the QoS condition; and
adopt the second signature for the verification process in response to the second verification time meeting the QoS condition.

10. The apparatus of claim 8, wherein the processor is further configured to:
generate a hash value according to the hash-based PQC algorithm and the signing data bound to the first random nonce; and
sign the hash value according to a private key to generate the first signature.

11. The apparatus of claim 8, wherein the QoS condition comprises a target time range.

12. The apparatus of claim 11, wherein the processor is further configured to:
determine that the first verification time meets the QoS condition in response to the first verification time being within the target time range; or
determine that the first verification time does not meet the QoS condition in response to the first verification time being over or less than the target time range.

13. The apparatus of claim 11, wherein the target time range is over a normal distribution or less than the normal distribution.

14. The apparatus of claim 8, wherein the hash-based PQC algorithm comprises an extended Merkle signature scheme (XMSS), a Leighton-Micali signature (LMS) or a SPHINCS+.
